(19) United States
(12) Patent Application Publication
(10) Pub. No.: US 2021/0331347 A1
(43) Pub. Date: Oct. 28, 2021

(54) ASSEMBLY AND METHOD FOR CONSTRUCTING CONCRETE STAIRWAYS AND STEPS

(71) Applicant: Tony Glentz, Goshen, IN (US)

(72) Inventor: Tony Glentz, Goshen, IN (US)

(21) Appl. No.: 17/230,038

(22) Filed: Apr. 14, 2021

Related U.S. Application Data
(60) Provisional application No. 63/015,525, filed on Apr. 25, 2020.

(51) Int. Cl. B28B 7/22

(52) U.S. Cl. CPC B28B 7/225

(57) ABSTRACT

An assembly for constructing concrete stairways and stairs that includes siderails that are configured to the attached to the walls on either side of an area where a stairway is to be constructed. A plurality of riser brackets and tread brackets are pivotally and slidably coupled to the siderails and pivotally and slidably connected to one another so as to allow for height, length and level adjustment of the individual riser brackets and tread brackets. The configuration further allows the riser brackets and trend brackets to fold up and be linearly aligned with the siderails for transportation and storage.

### RELATED APPLICATION

The present application is based on U.S. Provisional Application No. 63/015,525, filed Apr. 25, 2020 to which priority is claimed under 35 U.S.C. § 120 and of which the entire specification is hereby expressly incorporated by reference.

### BACKGROUND

The present invention relates generally to an assembly for constructing concrete stairways and steps and to methods of constructing concrete stairways and steps.

The construction of concrete stairways and stairs is very labor intensive with a significant amount of the work involving constructing the form or framework into which the concrete is poured to form the steps.

The initial step in constructing any stairway involves calculating the overall dimension of the stairway. In this step the overall height of the stairway area is measured and divided by the desired height of the risers to determine the number of risers required. Generally, risers should not be less than 4 inches tall and should not exceed 7.5 inches tall. Next the size of the treads is determined based on building codes that typically require treads that are at least 11 inches long. Overall, the number of treads is always one less than the number of risers.

Once the overall dimension of the stairway is determined, the formwork needs to be built and secured along the walls between where the stairway will be constructed. The formwork is built by hand usually from scrap or low-grade lumber. As the formwork is built it must be leveled and checked to ensure it conforms to the overall calculated dimension of the stairway, including each riser and tread. As the formwork is built any variance from the calculate dimensions that is discovered could necessitate rebuilding a portion or all of the formwork.

As can be appreciated, building the formwork is both labor intensive and time consuming.

U.S. Pat. No. 8,262,055 to Costello et al. and U.S. Pat. No. 5,133,530 to Thoresen disclose complex systems for casting concrete stairways.

The present invention provides an assembly or system for constructing concrete stairways and steps that is portable, easy to use and timesaving.

### BRIEF SUMMARY

According to various features, characteristics and embodiments of the present invention which will become apparent as the description thereof proceeds, the present invention provides an assembly for constructing a concrete stairway which comprises:

a siderail having a longitudinal slot therein;

a plurality of riser brackets, including end riser brackets at opposite ends of the assembly, each of the plurality of riser brackets having upper portions and lower ends; and

a plurality of tread brackets, including end tread brackets at opposite ends of the assembly, each of the plurality of tread brackets having inner ends and outer portions,

wherein a lower end of each of the plurality of riser brackets, other than an end riser bracket is attached to an inner end of one of the plurality of tread brackets, other than an end tread bracket, and an outer end of each of the plurality of tread brackets, other than an end tread bracket is attached to the upper portion of one of the plurality of riser bracket, other than an end riser bracket, and

wherein the plurality of riser brackets and the plurality of tread brackets are pivotally and slidably coupled to the siderail.

### BRIEF DESCRIPTION OF THE DRAWINGS

The present invention will be described with reference to the attached drawings which are given as non-limiting examples only, in which:

FIG. 1 is a perspective view of an assembly of the present invention arranged to pour a concrete stairway.

FIG. 2 is an aligned view of a pair of assemblies of the present invention in their folded or retracted states.

FIG. 3 is a front view of an isolated pair of riser and tread brackets according to one embodiment of the present invention.

FIG. 4 is a front view of a complete assembly having a plurality of riser brackets and tread brackets.

FIG. 5 is a front view of a complete assembly having a plurality of riser brackets and treads brackets that is similar to FIG. 4 in which the tread brackets have been adjusted to provide treads with longer lengths.

### DETAILED DESCRIPTION OF THE DRAWINGS AND THE PRESENTLY PREFERRED EMBODIMENTS

The present invention provides an assembly or system for constructing concrete stairways and steps and to methods of constructing concrete stairways and steps. The assembly or system of the present invention is portable and easy to use and avoids prior art methods that involve building formworks from scrap and low-cost lumber. The assembly or system of the present invention can be set up in a fraction of the time a worker can manually build a formwork. Further the present assembly or system allows for easy adjustment at any stage of set up without requiring tearing down and starting over.

The assembly or system of the present invention includes siderails that can be secured to walls adjacent to where a stairway will be constructed. The siderails include a longitudinal slot that extends along the length of the siderails. The slot is provided in the outward face of the siderails. The outward face being the surface that faces outward from a wall to which the siderails are attached. The siderails are configured so that the outward face is spaced away from the wall by a distance of 2 inches or greater.

The assembly or system of the present invention further includes riser brackets and tread brackets. The inner ends of the trend brackets are connected to the lower ends of the riser brackets. The connection between the inner ends of the trend brackets and blower ends of the riser brackets can be achieved by mechanical fasteners such as threaded bolts and nuts or any suitable type of fasteners.

The outer portion of the trend bracket are provided with elongated slots for adjustment purposes which will be explained below. The upper portion of the riser brackets are also provided with elongated slots for adjustment purposes which will be explained blow.

In use, the upper portion of a riser bracket is attached to the outer portion of an adjacent higher trend bracket in an adjustable manner by connecting the upper portion of the riser bracket to the outer portion of the adjacent higher tread bracket using a mechanical fastener that extends though the elongated slots of each of the riser bracket and the higher trend bracket. In addition to extending through the slot in each of the riser brackets and trend brackets, the mechanical fastener also extends outward from the slot of the siderail that supports the adjustably connected riser brackets and trend brackets. One example of a suitable mechanical fastener that is suitable for such purposes of adjustably connecting the riser brackets and trend brackets to one another and to the siderail is a carriage bolt that extends outward from inside the siderail so that it does rotate in the slot in the siderail. Such a carriage bolt can extend outward through the slot in the siderail and through the slot in the inner portion of a trend bracket and the through the slot in the upper portion of a riser bracket and then receive a locking washer and internally threaded nut on the free end thereof.

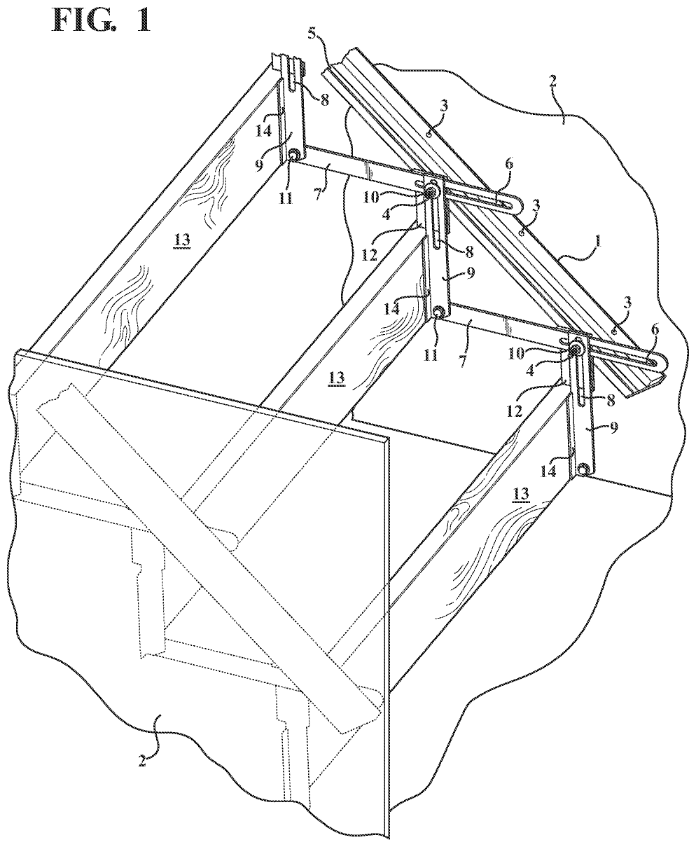

FIG. 1 is a perspective view of an assembly of the present invention arranged to pour a concrete stairway.

As shown in FIG. 1, a pair of assemblies according to the present invention is provided with one pair member being provided on opposite sides of an area where a concrete stairway is to be constructed. The siderails 1 are first secured to walls 2 between which the stairway will be constructed. The siderails 1 can be secured to the walls 2 by threaded fasteners 3 or other removable fasteners which will allow removal of the siderails 1 after a stairway is constructed.

As shown in FIG. 1, a carriage bolt 4 or other suitable mechanical fastener extends outward from slot 5 formed in the siderails 1 and is configured to slide long slot 5 for purposes of adjusting the assembly as discussed herein.

The carriage bolts 4 extend through slots 6 provided in the outer portions of the tread brackets 7 and through the slots 8 provided in the upper portions of the riser brackets 9. Threated nuts 10 provided on the ends of the carriage bolts 4 can be tightened to secure the assembly in a fixed configuration or loosened to adjust the assembly as desired.

As shown in FIG. 1 the lower ends of the riser brackets 9 and the inner ends of the tread brackets 7 are pivotally connected together by a mechanical fastener 11 that passes through through-holes provided in lower ends of the riser brackets 9 and inner ends of the tread brackets 7. As shown in FIG. 1, the lower end of the lowermost riser can be attached to wall 2 by a mechanical fastener.

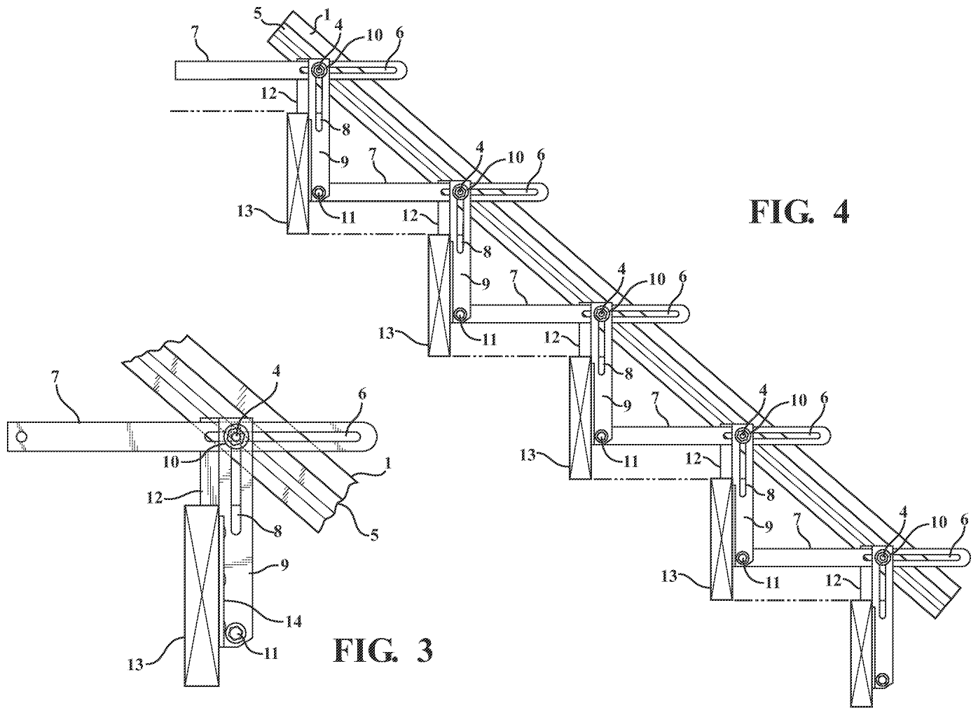

Rectangular spacer plates 12 are coupled by the carriage bolts 4 against the outer sides of the tread brackets 7. In this regard the rectangular spacer plates 12 have upper right-angled bent portions or flanges that rest against the tops of the tread brackets 7 and through-holes through which the carriage bolts 4 extend. The rectangular spacer plates 12 are configured to rest on the tops of boards 13 that are fastened to the lower portions of the riser brackets 9. The boards 13 serve as dams to contained poured concrete and form the front portions of steps in a stairway. The lower portions of the riser brackets 9 have inward or transversely bend portions or flanges 14 (See FIG. 3) provided with fastening holes through which wood screws, nails, or the like can applied to fasten opposite ends of the boards 13 to the lower portions of aligned riser brackets 9. As discussed below, the rectangular spacer plates 12 ensure there is sufficient clearance between the tread brackets 7 and the tops of boards 13 to allow the assemblies of the present invention to be folded or retracted.

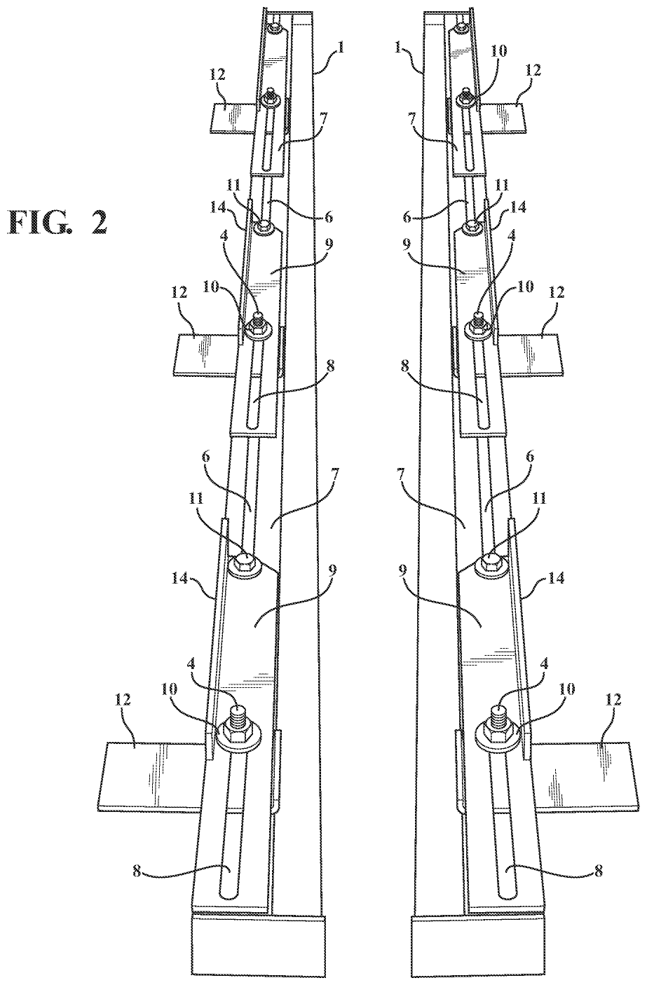

FIG. 2 is an aligned view of a pair of assemblies of the present invention in their folded or retracted states. As can be understood, the assembly used to construction a concrete stairway includes two assembly pair members, as shown in FIG. 2. When aligned as shown in FIG. 2 these pair members appear as mirror images of one another. In the folded or retracted state the carriage bolts 4 are at the lowest ends of the slots 8 provided in the lower portions of the riser brackets 9 and at the outer ends of the slots 6 provided in the outer portions of the tread brackets 7. The rectangular spacer plates 12 remain at right angles to their respective tread brackets 9 with their bent portions or flanges 14 against what would be the top surfaces of the tread brackets 7 when the assembly pairs are installed for a stairway construction. As can be appreciated, in their folded or retracted state, the assemble pair members are compact for transportation and storage convenience.

FIG. 3 is a front view of an isolated pair of riser and tread brackets according to one embodiment of the present invention. FIG. 3, best depicts how the carriage bolts 4, that can be loosened to slide along the slots 5 in the siderails 1, couples the each of the rectangular spacer plates 12, tread brackets 7 and riser brackets 9 together, When the carriage bolts 4 are loosened, the illustrated configuration allows for pivotal movement of the rectangular spacer plates 12 and tread brackets 7 (together), and riser brackets 9 about the carriage bolts 4. In addition, the cooperation of the carriage bolts 4 within and with respect to the slots 8 provided in the riser brackets 9 and the slots 6 in the trend brackets 7 allows for sliding movement of the riser brackets 9 and riser brackets 7 with respect to the carriage bolts 4 (when the carriage bolts are loosened).

Because the riser brackets 9 and tread brackets 7 are able to both pivot and slide with respect to the carriage bolts 4 the assembly of the present invention provides for an extensive range of adjustments that can be used to easily adjust the level of the risers and treads as well as the dimensions of the height of the risers and length of the treads of a stairway that is to be poured and formed from concrete without having to remove and replace wooden framework as was necessary in the prior methods of fabricating wooden framework.

FIG. 4 is a front view of a complete assembly having a plurality of riser brackets and tread brackets. In viewing FIG. 4 one can easily see and understand how any individual riser bracket 9 can be adjusted, height-wise by the sliding cooperation of each riser bracket's slot 8 about the carriage bolts 4 and likewise how any individual tread bracket 7 can be adjusted, length-wide by the sliding cooperation of each tread bracket's slot 6 about the carriage bolts 4.

As can be understood from the description of the present invention taken together with the drawing figures, the manner in which the riser brackets and trend brackets are adjustably attached together and to the siderail, allows for easy adjustment of the height of the risers and depth of the trends in the final constructed stairway. In this regard the slots in the upper portions of the riser brackets are of a sufficient length to adjust the height of the risers in the constructed stairway from about 7.25 inches to about 12 inches and the slots in the inner portions of the tread brackets are of sufficient length to adjust the length of treads in the constructed stairway from 9.25 inches to about 14 inches or greater.

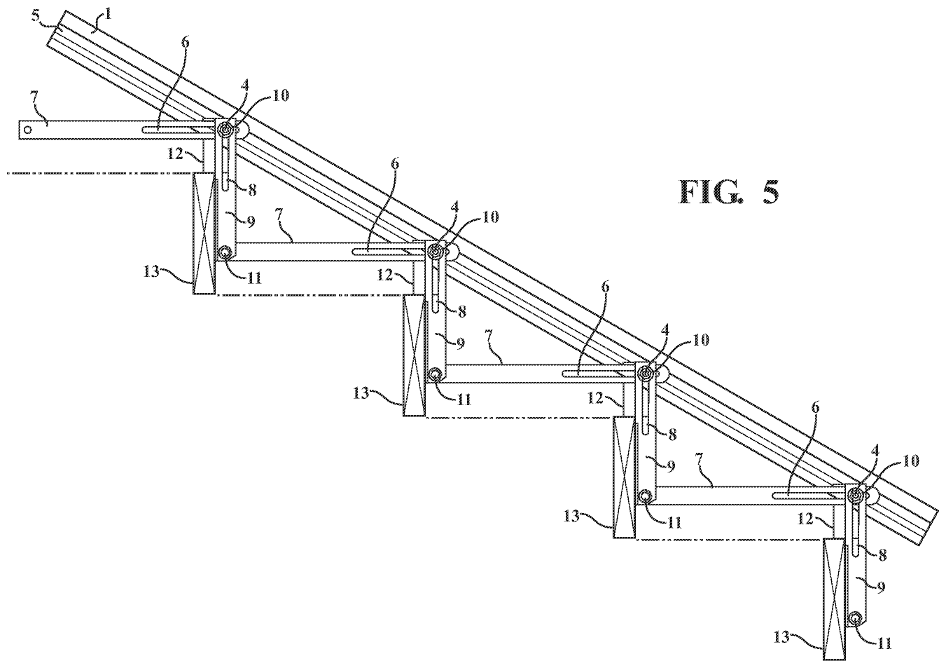

FIG. 5 is a front view of a complete assembly having a plurality of riser brackets and treads brackets that is similar to FIG. 4 in which the tread brackets have been adjusted to provide treads with longer lengths. FIG. 5 indicates how the configuration of the assemblies of the present invention allow for easy adjustment of the treads of a stairway. In a similar manner the heights of the risers of a stairway can be similarly adjusted according to the present invention

The siderails and riser brackets and trend brackets are preferable made from metal and in various embodiments can include measurement scales that can be used to verify desired target dimensions of the final constructed stairway. Such measurement scales can be attached to or formed on the surfaces of the riser brackets and the trend brackets.

According to an alternative embodiment of the present invention the lower ends of the riser brackets 9 and the inner ends of the tread brackets 7 can be fixed at a right angle or a single right-angled bracket having slots in each end portion could be used in place of the riser brackets 9 and tread brackets 7. This alternative embodiment would allow for adjustment of the riser height and tread length but would not allow for folding the assemblies in the manner shown in FIG. 2.

In use a pair of assemblies are attached across from each other on the walls between which a stairway will be constructed. Next the riser brackets 9 and tread brackets 7 are adjusted to the desired heights of the risers and desired lengths of the treads of the stairway and boards are attached to the bottoms of opposed riser brackets 9 so as to extend across the stairway area.

After the concrete is poured, troweled and brushed the assembly pair members are retracted or folded up so that the riser brackets 9 and tread brackets 7 are aligned alone the siderails are shown in FIG. 2 and the boards and the assembly pair members are removed.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. An assembly for constructing a concrete stairway which comprises:
a siderail having a longitudinal slot therein;
a plurality of riser brackets, including end riser brackets at opposite ends of the assembly, each of the plurality of riser brackets having upper portions and lower ends; and
a plurality of tread brackets, including end tread brackets at opposite ends of the assembly, each of the plurality of tread brackets having inner ends and outer portions,
wherein a lower end of each of the plurality of riser brackets, other than an end riser bracket is attached to an inner end of one of the plurality of tread brackets, other than an end tread bracket, and an outer end of each of the plurality of tread brackets, other than an end tread bracket is attached to the upper portion of one of the plurality of riser bracket, other than an end riser bracket, and
wherein the plurality of riser brackets and the plurality of tread brackets are pivotally and slidably coupled to the siderail.

2. An assembly for constructing a concrete stairway according to claim 1, wherein the plurality of riser brackets and the plurality of tread brackets are coupled to the siderail by a threaded member that extends outward from the longitudinal slot in the siderail.

3. An assembly for constructing a concrete stairway according to claim 2, wherein the upper portions of the plurality of riser brackets include slots therein.

4. An assembly for constructing a concrete stairway according to claim 3, wherein the outer portions of the plurality of tread brackets include slots therein.

5. An assembly for constructing a concrete stairway according to claim 4, wherein the plurality of riser brackets and the plurality or tread brackets are pivotally and slidably coupled to the side rail by the treaded members which extend outwardly from the longitudinal slot in the siderail and through the slots in the plurality of riser brackets and slots in the plurality of tread brackets.

6. An assembly for constructing a concrete stairway according to claim 1, wherein the lower ends of the plurality of riser brackets are pivotally attached to the inner ends of the plurality of tread brackets.

7. An assembly for constructing a concrete stairway according to claim 2, wherein the plurality or riser brackets and the plurality of tread brackets can be arranged to be linearly aligned with the siderail.

8. An assembly for constructing a concrete stairway according to claim 1, wherein lower portions of the plurality of riser brackets include flanges for attaching boards thereto.

9. An assembly for constructing a concrete stairway according to claim 3, wherein the plurality of riser brackets include measurement scales adjacent the slots.

10. An assembly for constructing a concrete stairway according to claim 4, wherein the plurality of tread brackets include measurement scales adjacent the slots.

11. An assembly for constructing a concrete stairway according to claim 8, further comprising spacer plates attached to the plurality of tread brackets and configured to rest on tops of boards that are attached to the flanges of the riser brackets.
